(19) United States
(12) Patent Application Publication
(10) Pub. No.: US 2012/0085849 A1
(43) Pub. Date: Apr. 12, 2012

(54) BOWL MILL DEFLECTOR

(75) Inventors: Melissa Knope, Ellington, CT (US); Lawrence S. Farris, East Granby, CT (US); Todd Williams, Ellington, CT (US)

(73) Assignee: ALSTOM TECHNOLOGY LTD, Baden (CH)

(21) Appl. No.: 12/900,537

(22) Filed: Oct. 8, 2010

(51) Int. Cl. B02C 15/00

(52) U.S. Cl. 241/101.2; 241/117

(57) ABSTRACT

A deflector (30) for a pulverizing bowl mill (10) includes a plurality of first upper plates (72) and a plurality of second upper plates (74) arranged with the first upper plates (72) to form the deflector (30) positionable on an inner surface of a substantially closed separator body (12) of the pulverizing bowl mill (10). Each of the second upper plates (74) comprises a skirted lower edge (75) that extends beyond a lower edge of each of the first upper plates (72). Each of the second upper plates (74) is also positionable in the pulverizing bowl mill (10) upstream of a journal (24) supporting a grinding roller (22) to deflect a flow of air (32) around the journal (24).

### TECHNICAL FIELD

The present disclosure is generally directed to a pulverizer for the grinding of materials and, more particularly, to a deflector for a bowl mill pulverizer.

### BACKGROUND

Pulverizers are used to grind materials for use in various applications. One material that may be ground using a pulverizer is coal for use in fossil fuel fired power generation systems. The coal is typically fed to the pulverizer in the form of large chunks, and the pulverizer breaks the large chunks into smaller particles for use in the power generation systems.

One type of pulverizer used to grind coal is a bowl mill A bowl mill includes a grinding table rotatably mounted on a central axis, a plurality of grinding rollers supported on journals, and an inlet for supplying coal to the grinding table. The grinding rollers interact with an upper surface of the grinding table. Large chunks of coal are received between the grinding rollers and the upper surface of the grinding table and are crushed therebetween. An air stream is also supplied to the bowl mill for picking up the crushed coal, returning large particles of coal to the grinding table for regrind, and removing the suitably ground coal.

During a coal grinding operation, the air supplied to the bowl mill becomes entrained with coal particles. Because of the path of the air flow through the bowl mill, the coal-entrained air is blown into close proximity with the journals supporting the grinding rollers, which contain bearings as well as other moving parts. Deflectors are often employed to direct the flow of the coal-entrained air through the bowl mill. However, due to the turbulent flow of air through the bowl mill as well as placement of the deflectors relative to the journals, coal particles generally come into contact with the moving parts of the journals.

### SUMMARY

According to a first aspect illustrated herein, there is provided a bowl mill comprising a substantially closed separator body; a rotatable grinding table mounted for rotation within the substantially closed separator body and upon which pulverization of material is effected; a plurality of grinding rollers for pulverizing the material on the rotatable grinding table, each of the plurality of grinding rollers being supported by a corresponding journal; a vane wheel affixed to a peripheral edge of the rotatable grinding table, the vane wheel comprising a plurality of vanes; and a deflector mounted within the substantially closed separator body in a spaced relationship to the peripheral edge of the rotatable grinding table, thereby defining an annular space between the deflector and the peripheral edge of the rotatable grinding table. The deflector comprises a plurality of first plates extending from an inner surface of the substantially closed separator body and a plurality of second plates extending from the inner surface of the substantially closed separator body, the second plates having skirted lower edges that extend into the annular space between the deflector and the peripheral edge of the rotatable grinding table to deflect a flow of air through the annular space. The second plates are positioned in the deflector upstream of the journals.

According to a second aspect illustrated herein, there is provided a pulverizing bowl mill comprising a substantially closed separator body; a rotatable grinding table mounted for rotation within the substantially closed separator body and upon which pulverization of material is effected; a plurality of grinding rollers for pulverizing the material on the rotatable grinding table, each of the plurality of grinding rollers being rotatably supported by a corresponding journal and being configured to interact with an upper surface of the rotatable grinding table; a vane wheel affixed to a peripheral edge of the rotatable grinding table, the vane wheel comprising a plurality of vanes; an air stream received into the substantially closed separator body and directed through the vane wheel and to at least the peripheral edge of the upper surface of the rotatable grinding table; and a deflector mounted within the substantially closed separator body in a spaced relationship to the peripheral edge of the rotatable grinding table, thereby defining an annular space between the deflector and the peripheral edge of the rotatable grinding table. The deflector comprises a plurality of first plates extending from an inner surface of the substantially closed separator body and a plurality of second plates extending from the inner surface of the substantially closed separator body, the second plates having skirted lower edges that extend into the annular space between the deflector and the peripheral edge of the rotatable grinding table to deflect the air stream through the annular space, the second plates being positioned in the deflector upstream of the journals.

According to a third aspect illustrated herein, there is provided a deflector for a pulverizing bowl mill, the deflector comprising a plurality of first upper plates and a plurality of second upper plates arranged with the first upper plates to form the deflector positionable on an inner surface of a substantially closed separator body of the pulverizing bowl mill Each of the second upper plates comprises a skirted lower edge that extends beyond a lower edge of each of the first upper plates. Each of the second upper plates is also positionable in the pulverizing bowl mill upstream of a journal supporting a grinding roller to deflect a flow of air around the journal.

### BRIEF DESCRIPTION OF THE DRAWINGS

Referring now to the Figures, which are exemplary embodiments, and wherein like elements are numbered alike:

FIG. 1 is a side sectional view of a pulverizing bowl mill;

FIG. 2 is a side sectional view of a grinding table and a deflector of the pulverizing bowl mill of FIG. 1;

FIG. 3 is a side sectional view of a portion of a vane wheel of the pulverizing bowl mill of FIG. 1;

FIG. 4 is a side sectional view of a portion of the deflector;

FIG. 5 is a top view of the grinding table and deflector of the pulverizing bowl mill of FIG. 1; and

FIG. 6 is a computer screenshot of a simulation of air flow in the pulverizing bowl mill of FIG. 1.

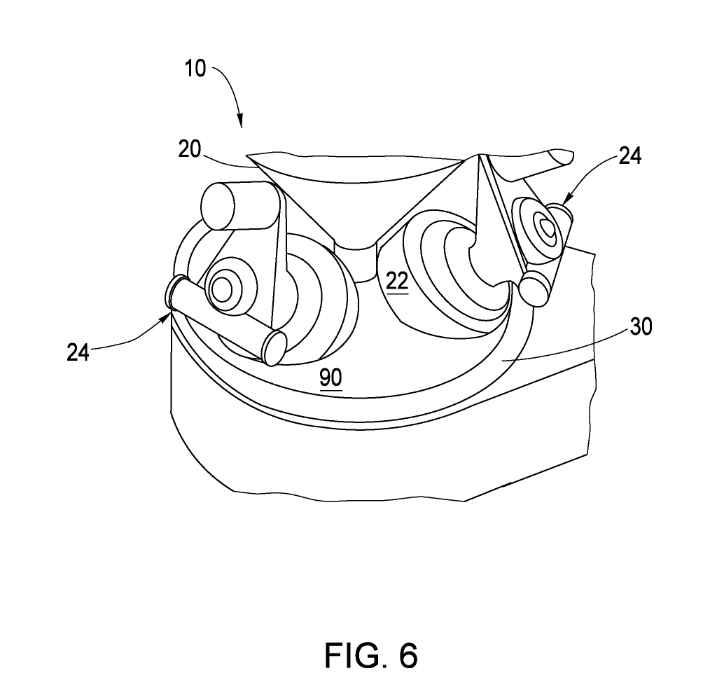

### DETAILED DESCRIPTION

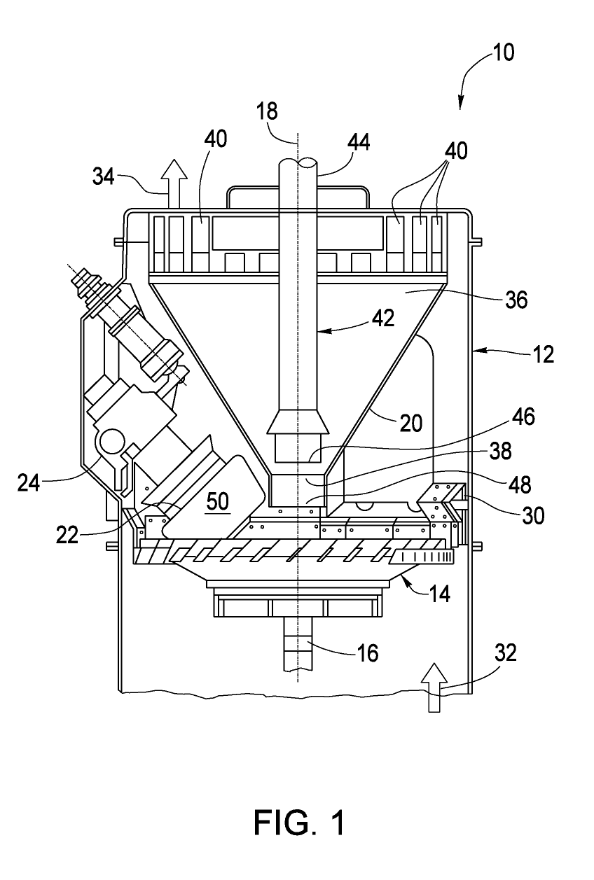

Referring to FIG. 1, a pulverizing bowl mill is designated generally by the reference numeral 10 and is hereinafter referred to as “mill 10.” The mill 10 includes a substantially closed separator body 12 in which a grinding table 14 is rotatably located on a shaft 16. The shaft 16 is coincident with a central axis 18 of the mill 10 and is operatively connected to a suitable drive mechanism so as to be capable of being rotatably driven, thereby rotatably driving the grinding table 14. A classifier 20 is centrally located on the central axis 18 and supported in the separator body 12. A plurality of grinding rollers 22 is supported on journals 24 located around the classifier 20. A deflector 30 is mounted within the interior of the separator body 12 above and in spaced relationship to an upper surface of the grinding table 14. The deflector 30 includes portions that direct air from an air feed stream 32 supplied to the mill 10 at a lower portion thereof upstream of and around the journals 24. An air outlet stream 34 containing a material containing particulates entrained therein is taken off at an upper end of the mill 10. Although the mill 10 is hereinafter described with regard to the grinding of coal, it should be understood that other desired materials can also be ground in the mill

The classifier 20 comprises a funnel-shaped body having an upper end 36 and an open lower end 38 that is narrower than the upper end. Openings 40 in the upper end 36 allow for the intake of air having coal entrained therein. Walls that define the funnel-shaped body are configured to manage the direction and velocity of air (and coal particles entrained therein) directed through the separator body 12. A duct 42 is received in the upper end 36 of the classifier 20 and is centrally located therein and coaxially aligned with the central axis 18. The duct 42 includes an inlet end 44 and an outlet end 46 that extends to the open lower end 38 of the classifier 20. Coal (e.g., large chunks of coal) from a suitable source is received into the duct 42 through the inlet end 44 and dispensed to the grinding table 14 from the outlet end 46. When dispensed from the outlet end 46, the coal is dropped through the open lower end 38 and onto the grinding table 14.

The journals 24 are located circumferentially around the classifier 20 and are hingedly mounted and spring-biased in the direction of the grinding table 14. Hingedly mounting and spring-biasing the journals 24 allows them to move to accommodate wear of the surface of the grinding rollers 22. An outer surface 50 of each grinding roller 22 is positioned such that a space (e.g., about 0.6 centimeters (cm) to about 1.0 cm) is defined between the outer surface of the grinding roller and the upper surface of the grinding table 14. Upon rotation of the grinding table 14, the grinding rollers 22 break up the larger chunks of coal (e.g., chunks of coal up to about 5 cm in diameter) and form a bed of smaller coal particles on the upper surface of the grinding table. Pressure exerted by downward action of the grinding rollers 22 on the bed of coal particles (which may be about 89,000 Newtons (N) to about 222,500 N) causes the sizes of the coal particles to be further reduced by attrition down to a fineness level at which about 70% of the coal particles are less than about 0.0076 cm. As the depth of the bed of coal particles increases, the grinding rollers 22 are urged upward against the spring, thereby causing them to continue to exert pressure on the coal particles.

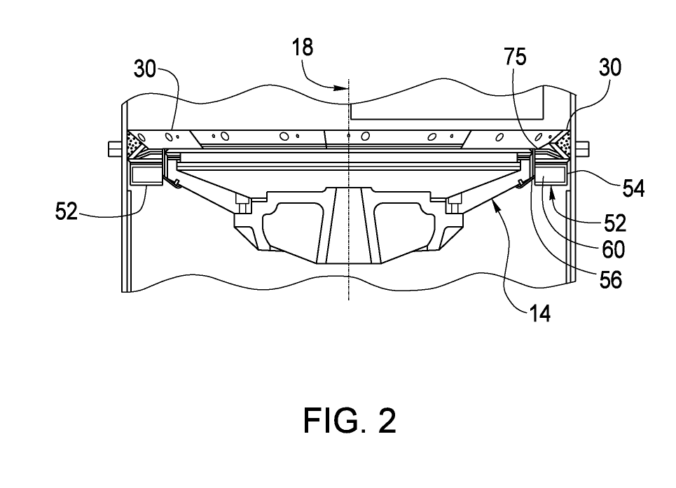

As shown in FIG. 2, the grinding table 14 includes a vane wheel 52. The vane wheel 52 is constructed to be affixed to and extend circumferentially around the periphery of the grinding table 14 and below the peripheral edge of the grinding table (and thereby below the deflector 30). The vane wheel 52 includes an outer shroud 54 and a concentrically located inner shroud 56 with vanes 60 mounted so as to be equally spaced relative to each other between the inner shroud 56 and the outer shroud 54 and around the circumference of the vane wheel 52. The vanes 60 operatively interconnect the inner shroud 56 and the outer shroud 54. The vane wheel 52 is affixed to the grinding table 14 using any suitable means, e.g., a bolt or the like.

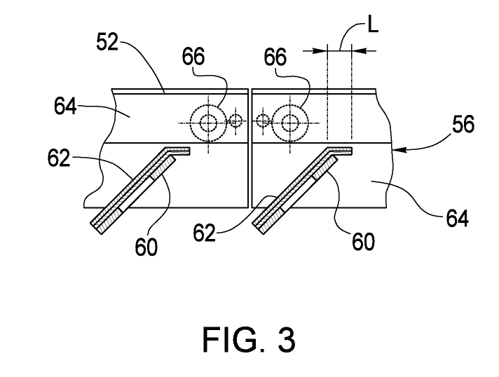

As shown in FIG. 3, each vane 60 includes an abrasion resistant liner 62 to protect the vane from wear that would otherwise be incurred from the vane being contacted by particles of coal that are entrained in the air as the air flows through the vane wheel 52. The length L of the horizontal portion of each vane 60 provides control over the velocity of the air upward through the vane wheel 52 and into the separator body 12. Furthermore, a plurality of inner shroud liners 64 may be located on an outwardly facing surface of the inner shroud 56 (the surface to which the vane 60 is attached) to protect the inner shroud from wear from contact by coal particles. The inner shroud liners 64 may be attached to the inner shroud 56 via any suitable means, e.g., via welding or fasteners such as rivets or bolts 68.

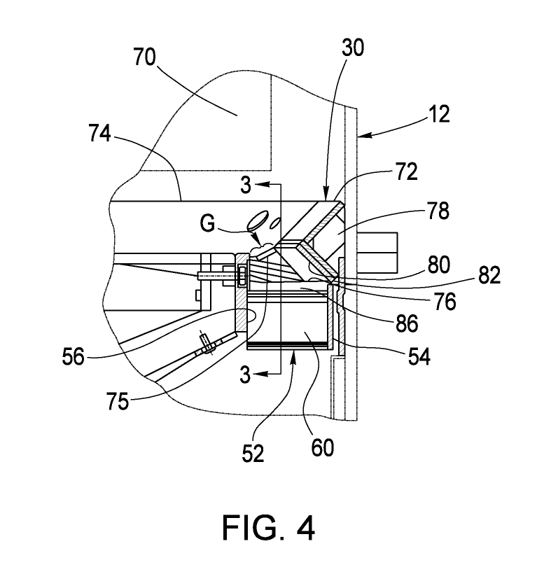

As shown in FIG. 4, the deflector 30 is mounted to an inner wall defined by the separator body 12 and positioned below the elevation at which doors 70 are located in the separator body to provide access to the journals 24. The deflector 30 provides a substantially continuous structure around the inner surface of the separator body 12 proximate the periphery of the grinding table 14.

The deflector 30 comprises a plurality of upper and lower plates arranged at angles relative to each other and supported on the inner wall of the separator body 12. In particular, the deflector comprises a plurality of upper plates 72, skirted upper plates 74, and lower plates 76 such that the upper plates (and the skirted upper plates) are angled at about 90 degrees relative to lower plates and so as the upper plates form an angle of about 45 degrees relative to the inner wall of the separator body 12. The skirted upper plates 74 each include a skirted lower edge 75. The upper plates 72, the skirted upper plates 74, and the lower plates 76 may be supported on the inner wall of the separator body 12 using any suitable fastening means and are connected to each other. As shown, the plates are fastened to each other and to the inner wall of the separator body 12 via the use of gussets 78. A liner surface 80 is disposed on the lower plates 76. The present liner surface 80 is not limited being disposed on the lower plates 76, however, as the liner surface may also be located on the upper plates 72 and/or the skirted upper plates 74. A bead 82 of sealant material may be disposed around an edge of the lower plates 76 where the lower plates attach to the inner surface of the separator body 12 in order to inhibit leakage of air or coal particles from a lower end of the separator body to behind the deflector 30. One type of sealant material that may be used is RTV (room temperature vulcanizing) elastomeric sealant.

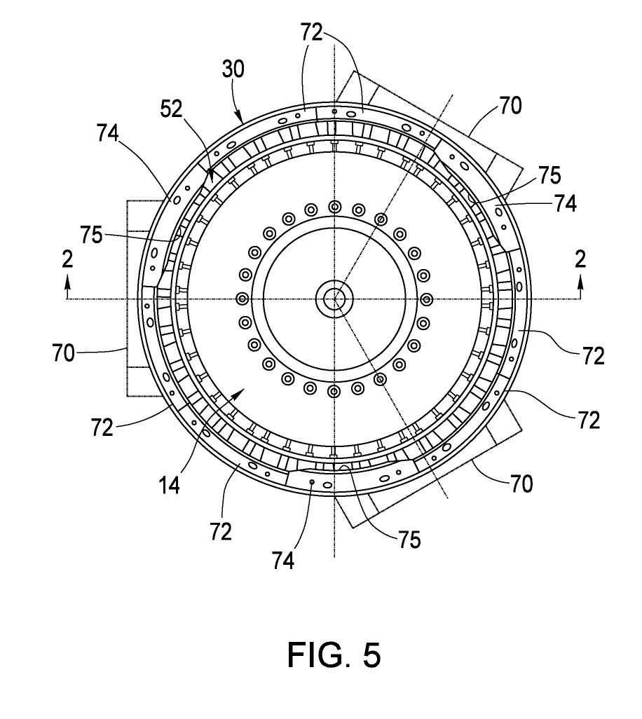

As shown in FIG. 5, the skirted upper plates 74 and the upper plates 72 are arranged to form the deflector 30 such that the skirted upper plates are positioned upstream of the doors 70 in the separator body that provide access to the journals 24. Thus, the skirted upper plates 74 are not located directly under the journals 24 but are instead offset therefrom. In so positioning the skirted upper plates 74, the skirted lower edges 75 direct the flow of air around the journals 24 and to more open areas between the journals. As shown, the upper plates 72 and the skirted upper plates 74 of the deflector 30 are arranged to have a gap between adjacent plates, the gap being filled with an RTV elastomeric sealant. The positioning of the deflector 30 relative to the grinding table 14 provides for an annular passage defining a gap G (shown at 86 in FIG. 4) therebetween, below which the vane wheel 52 is located.

During operation, as shown in all the Figures, the air feed stream 32 is fed to the lower portion of the mill 10. As the grinding table 14 (and the vane wheel 52) rotates, the movement of the vanes 60 directs the flow of air upward from an upper area (shown at 86 in FIG. 4) of the vane wheel 52 and along the lower plates 76 and through the gap G defined by the outer edge of the grinding table 14 and an innermost edge of the deflector 30. A 360 degree air flow is thereby directed through the mill 10, e.g., the air flow through the mill is substantially uniform around the inner surface of the separator body 12.

Because a width of the upper area 86 is greater than a width of the gap G, a converging nozzle effect is created thus preventing a decrease in air velocity as the air passes between the rim of the grinding table 14 and the deflector 30. The velocity of the air at the rim of the grinding table 14 causes larger coal particles to be directed back onto the upper surface of the grinding table and helps prevent these particles from falling below the outer edge of the grinding table and into the vanes 60 of the vane wheel 52. Once the air passes through the gap G, the air undergoes a substantial drop in velocity, thereby causing larger particles of coal entrained therein to be returned to the grinding table 14. The coal that has been pulverized into the desirable smaller particles is flung off the grinding table 14, entrained in the air, and carried up along the outer surface of the body of the classifier 20, through the openings 40, and is discharged from the mill 10. Particles of coal that are too big to pass through the openings fall back along the inner surface of the separator body 12 and back onto the grinding table 14. Particles of coal that pass through the openings 40 but cannot be discharged in the air outlet stream 34 (e.g., due to size) fall back through the classifier 20 and onto the center of the grinding table 14.

Because the skirted lower edges 75 of the skirted upper plates 74 extend into the gap G between the rim of the grinding table 14 and the deflector 30, the air is directed around the skirted upper plates. Because the skirted upper plates 74 are offset or upstream of the journals 24, the air flow is directed around the journals.

As shown in FIG. 7, a computer simulation of a coal-entrained air flow 90 around the skirted upper plates 74 of the deflector 30 offset or upstream of the journals 24 indicates that desirable operation is attained and suitable amounts of erosion of the journals and related components are realized.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A bowl mill, comprising:
a substantially closed separator body;
a rotatable grinding table mounted for rotation within the substantially closed separator body and upon which pulverization of material is effected;
a plurality of grinding rollers for pulverizing the material on the rotatable grinding table, each of the plurality of grinding rollers being supported by a corresponding journal;
a vane wheel affixed to a peripheral edge of the rotatable grinding table, the vane wheel comprising a plurality of vanes; and
a deflector mounted within the substantially closed separator body in a spaced relationship to the peripheral edge of the rotatable grinding table, thereby defining an annular space between the deflector and the peripheral edge of the rotatable grinding table, the deflector comprising,
a plurality of first plates extending from an inner surface of the substantially closed separator body, and
a plurality of second plates extending from the inner surface of the substantially closed separator body, the second plates having skirted lower edges that extend into the annular space between the deflector and the peripheral edge of the rotatable grinding table to deflect a flow of air through the annular space, the second plates being positioned in the deflector upstream of the journals.

2. The bowl mill of claim 1, further comprising, a plurality of third plates extending from the inner surface of the substantially closed separator body, each of the third plates being connected to a respective first plate at an end thereof distal from the inner surface of the substantially closed separator body and arranged to form an angle with the first plate.

3. The bowl mill of claim 2, further comprising a plurality of liner surfaces, each of the liner surfaces being disposed on a surface of a respective third plate to protect the third plate from wear.

4. The bowl mill of claim 1, further comprising a plurality of gussets attached to the inner surface of the substantially closed separator body, each of the gussets providing support for the first plates and the second plates.

5. The bowl mill of claim 1, further comprising a plurality of abrasion resistant liners, each of the abrasion resistant liners being disposed on a surface of a respective vane to protect the vane from wear.

6. The bowl mill of claim 1, wherein each vane comprises a horizontal portion to provide control over the velocity of the flow of air through the annular space.

7. A pulverizing bowl mill, comprising:
a substantially closed separator body;
a rotatable grinding table mounted for rotation within the substantially closed separator body and upon which pulverization of material is effected;
a plurality of grinding rollers for pulverizing the material on the rotatable grinding table, each of the plurality of grinding rollers being rotatably supported by a corresponding journal and being configured to interact with an upper surface of the rotatable grinding table;
a vane wheel affixed to a peripheral edge of the rotatable grinding table, the vane wheel comprising a plurality of vanes;
an air stream received into the substantially closed separator body and directed through the vane wheel and to at least the peripheral edge of the upper surface of the rotatable grinding table; and
a deflector mounted within the substantially closed separator body in a spaced relationship to the peripheral edge of the rotatable grinding table, thereby defining an annular space between the deflector and the peripheral edge of the rotatable grinding table, the deflector comprising,
a plurality of first plates extending from an inner surface of the substantially closed separator body, and
a plurality of second plates extending from the inner surface of the substantially closed separator body, the second plates having skirted lower edges that extend into the annular space between the deflector and the peripheral edge of the rotatable grinding table to deflect the air stream through the annular space, the second plates being positioned in the deflector upstream of the journals.

8. The bowl mill of claim 7, further comprising a plurality of third plates extending from the inner surface of the substantially closed separator body, each of the third plates being connected to a respective first plate at an end thereof distal from the inner surface of the substantially closed separator body and arranged to form an angle of about 90 degrees with the first plate.

9. The bowl mill of claim 8, further comprising a plurality of liner surfaces, each of the liner surfaces being disposed on a surface of a respective third plate to protect the third plate from wear.

10. The bowl mill of claim 7, further comprising liner surfaces disposed on at least one of the first plates and the second plates to protect at least one of the first plates and the second plates from wear.

11. The bowl mill of claim 7, further comprising a plurality of abrasion resistant liners, each of the abrasion resistant liners being disposed on a surface of a respective vane to protect the vane from wear.

12. A deflector for a pulverizing bowl mill, the deflector comprising:
a plurality of first upper plates; and
a plurality of second upper plates arranged with the first upper plates to form the deflector positionable on an inner surface of a substantially closed separator body of the pulverizing bowl mill, each of the second upper plates comprising a skirted lower edge that extends beyond a lower edge of each of the first upper plates;
wherein each of the second upper plates is positionable in the pulverizing bowl mill upstream of a journal supporting a grinding roller to deflect a flow of air around the journal.

13. The deflector of claim 12, further comprising a plurality of lower plates, each of the lower plates being arranged at an angle of about 90 degrees relative to each of the first upper plates and being connected to the first upper plates and to the inner surface of a substantially closed separator body.

14. The deflector of claim 13, further comprising a plurality of liner surfaces, each of the liner surfaces being disposed on a surface of a respective lower plate to protect the lower plate from wear.

15. The deflector of claim 13, further comprising a bead of sealant material disposed around a joint defined by each of the lower plates and the inner surface of a substantially closed separator body.

16. The deflector of claim 15, wherein the sealant material is a room temperature vulcanizing elastomeric sealant.

17. The deflector of claim 12, wherein a gap is defined between each of the adjacently-positioned first plates and second plates.
